(19) United States
(12) Patent Application Publication
(10) Pub. No.: US 2010/0157352 A1
(43) Pub. Date: Jun. 24, 2010

(54) METHOD AND SYSTEM FOR CREATING VISUAL REPRESENTATION OF WYSIWYG FINISHING INSTRUCTIONS FOR SPECIALTY PHOTO MEDIA

(76) Inventors: Javier A. Morales, Rochester, NY (US); Michael E. Farrell, Webster, NY (US)

Correspondence Address: Xerox Corporation;c/o ORTIZ & LOPEZ, PLLC, P. O. BOX 4484, ALBUQUERQUE, NM, 87196-4484, US

(21) Appl. No.: 12/339,626

(22) Filed: Dec. 19, 2008

(51) Int. Cl. G06F 3/12; G06F 3/048

(52) U.S. Cl. 358/1.15; 715/764

(57) ABSTRACT

A method and system for creating a visual representation of instructions required to finish a photo product that utilizes a specialty photo media. A photo job requesting the specialty photo media can be received and the photo job then rendered on the specialty photo media via a rendering device. An ancillary instruction document along with a number of thumbnails representing the photo job can also be rendered via the rendering device. The ancillary instruction document includes a number of instructions required to generate the final photo product on the specialty photo media thereby reducing wastage of very expensive media. The finishing instructions can be alternatively represented as animations on a graphical user interface.

### TECHNICAL FIELD

Embodiments are generally related to rendering devices and techniques. Embodiments also relate in general to the field of computers and similar technologies and, in particular, to software utilized in this field. In addition, embodiments relate to methods and systems for configuring a visual representation of finishing instructions for specialty photo media.

### BACKGROUND OF THE INVENTION

WYSIWYG, is an acronym for “What You See Is What You Get”, an approach that is utilized in computing and image processing to describe content displayed during editing that appears very similar to a final output, which may be, for example, a rendered document, a web page, a slide presentation or even a lighting for a theatrical event, etc. WYSIWYG implies a user interface that allows a user to view something very similar to the end result while the document is being created. A typical WYSIWYG application can provide a high-quality rendered output and/or a high-quality onscreen output and allow the user to visualize what the document may look like when rendered.

Many current rendering approaches include a WYSIWYG display function for displaying a document or portions of the document in a WYSIWYG format and generally include finishing options such as, for example, scaling, rotation, skewing, stapling, hole punching, folding and other options. Manufacturers typically provide a user interface that includes a means for selecting desired finishing options. Such finishing parameters are normally presented via a combination of icon and/or text labels that are capable of describing each finishing option so that the user may select particular finishing options. Of course, each finishing option that the particular system is capable of producing is normally displayed on the user interface, either in a summary window or on separate windows.

The majority of retail photo operations, which provide differentiated photo products through specialty photo media such as, for example, Flip Pix, may possess unique problems due to the combination of expensive media and high turnover in a retail environment. Note that “Flip Pix” is a trademark of IMCOM, Inc. of Salt Point, N.Y. Also, there are significant problems with current methods of selecting finishing parameter options for such photo operations. Such finishing option programming methods are indirect which requires a user to make selections by way of textual or GUI components such as, e.g., radio option buttons or combo box selections.

Unfortunately, the user necessarily parses through various finishing options and, therefore, makes many comparisons and decisions in order to achieve the desired outcome. Typically, the special behaviors and conflicts of such finishing system are confusing and awkward to the user and difficult to understand. In such situations, the employees may receive little training and may constantly jump between a variety of tasks. Such an approach can be problematic due to employee inattention, which in turn may lead to waste of expensive media. Hence, an improved approach for communicating finishing options to a user for selection by the user of the rendering system is desirable.

Based on the foregoing, it is believed that a need exists for an improved method and system for creating a visual representation(s) of document finishing instructions required to finish a photo product that utilizes specialty photo media, which assists in reducing waste of very expensive media, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for an improved method and system for configuring rendering devices, such as printers, scanners, multi-function devices, photocopy machines, and the like.

It is yet a further aspect of the present invention to provide for an improved method and system for creating a visual representation of instructions required to finish a photo product utilizing specialty photo media.

The aforementioned aspects and other objectives and advantages can now be achieved as described herein. A method and system for creating a visual representation of instructions required to finish a photo product that utilize a specialty photo media is disclosed. A photo job requesting the specialty photo media can be received and the photo job can be rendered on the specialty photo media via a rendering device. An ancillary instruction document along with a number of thumbnails representing the photo job can also be rendered via the rendering device. The ancillary instruction document includes a number of instructions required to generate the final photo product on the specialty photo media thereby reducing wastage of very expensive media. The finishing instructions can be alternatively represented as animations on a graphical user interface that similarly show the photo job in various stages of finishing.

The media definitions at the DFE (Digital Front End) can be enhanced to include a template for the ancillary document that can be rendered along with the photo job. The template can include a graphical representation of the steps required to finish the photo job rendered on the specialty photo product media. The template can also include a number of image placeholders into which a masked representation of the raster image processed photo job can be placed. A low-resolution image can also be created for placement into the finishing instructions template. The template associated with the selected media can be retrieved and the low-resolution image then placed in the image placeholders. Such image placeholders include a window for placing the image and information regarding how the image can be transformed as it is placed.

The photo job can be placed within this window and may be offset to show a given portion of the image associated with the photo job. The photo job can be rendered in the specialty photo media and then the ancillary instruction document comprising the finishing instructions of the photo job can be rendered. Such an approach associates the document template with the specialty photo media and automatically generates finishing instructions that show the actual photo job in various stages of finishing. Such a visual representation of the document finishing instructions reduces waste of very expensive media and provides greater customer satisfaction.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a block diagram of a system for creating visual representation of instructions required to finish a photo product that utilizes a specialty photo media, in accordance with a preferred embodiment;

FIG. 4 illustrates a graphical user interface window that displays the visual representation of instructions required to finish the photo product on the specialty photo media, which can be implemented in accordance with an exemplary embodiment; and

FIG. 5 illustrates a flow chart of operations illustrating logical operational steps of a method for creating a visual representation of instructions required to finish the photo product that utilizes the specialty product photo media, in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

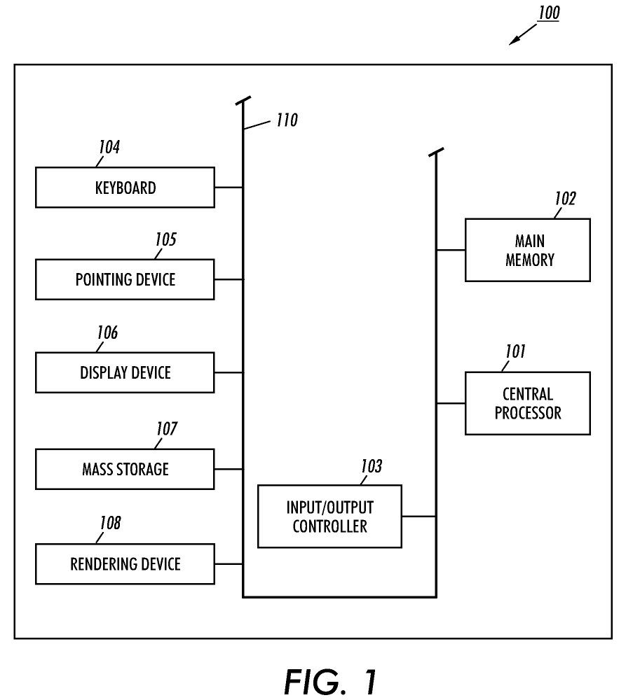

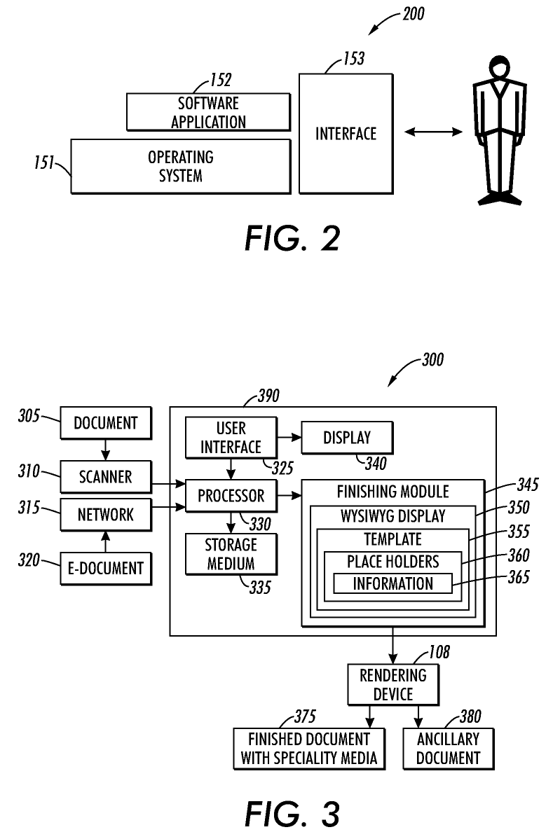

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied and/or implemented in the context of a data-processing system 100 that generally includes a central processor 101, a main memory 102, an input/output controller 103, an input device such as, for example, a keyboard 104, a pointing device 105 (e.g., mouse, track ball, pen device, or the like), a display device 106, and mass storage 107 (e.g., hard disk). Additional input/output devices, such as a rendering device 108, may be utilized in association with the data-processing system 100 as desired. As illustrated, the various components of the data-processing system 100 communicate through a system bus 110 or similar architecture.

Illustrated in FIG. 2, a computer software system 150 is provided for directing the operation of the data-processing system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152.

The interface 153, which is preferably a graphical user interface (GUI), also serves to display results, whereupon the user may supply additional inputs or terminate the session. In one particular embodiment, operating system 151 and interface 153 can be implemented in the context of a “Windows” system. In another embodiment, operating system 151 and interface 153 may be implemented in the context of other operating systems, such as Linux, UNIX, etc. Application module 152, on the other hand, can include instructions such as the various operations described herein with respect to the various components and modules described herein such as, for example, the method 500 depicted in FIG. 5.

The following description is presented with respect to embodiments of the present invention, which can be embodied in the context of a data-processing system such as data-processing system 100 and computer software system 150 depicted respectively in FIGS. 1-2. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

FIG. 3 illustrates a block diagram of a rendering system 300 for creating visual representation of instructions required to finish a photo product that utilizes a specialty photo media, in accordance with a preferred embodiment. Note that in FIGS. 1-5, identical or similar parts or elements are indicated by identical reference numerals. The rendering system 300 generally includes a workstation 390. The workstation 390 includes a user interface 325 for receiving commands and instructions from a user, a display device 340 for displaying instructions and documents to the user, and a rendering device 108 connected to the workstation 390. Note that rendering device 108 may constitute, for example, a printer, a copier, fax machine, scanner, and/or other types of rendering components, depending upon design considerations. Thus, rendering device 108 may be a standalone single function device such as a dedicated printer, scanner, copy machine, etc. Rendering device 108 can also be, for example, a multi-function device capable of multiple rendering functions such as printing, copying, scanning, faxing, etc. Rendering device 108 may also be, for example, a photo processing and/or image processing device such as those utilized in retail photo processing establishments and businesses.

The workstation 390 can be configured to further include a processor 330 and a storage medium 335 suitable for running a multiple finishing module 345 that provide visual representation of instructions required to finish a photo product on a specialty photo product media. The disk storage units may be either locally or remotely connected. With reference to FIG. 3, portions of the rendering system 300 suitable for incorporating concepts of the present application are shown. Only portions of the rendering system 300 that facilitate an understanding of the present application are shown. It is to be understood that although the present application is described in terms of a rendering system, the concepts described herein are equally suitable for other systems having a finishing system.

As shown, the exemplary system 300 can include a scanner 310, which may be any of a variety of scanners known in the art. The scanner 310 scans input documents 305 to produce digital documents which are then inputted to the processor 330. The processor 330 can also be configured to include or accesses a network connection 315 for receiving electronic documents 320 over a computer network (i.e., wireless and/or wire line). Note that as utilized herein the term “document” can refer to a photo job, a photoproduct and/or other photo representations.

The multiple finishing module 345 includes a WYSIWYG display function 350 in case the user opts to display the document being prepared in a WYSIWYG format. WYSIWYG implies a user interface that allows the user to view something very similar to the end result while the document is being created. A typical WYSIWYG application can provide a high-quality rendered output on a particular or a variety of computers, a high-quality onscreen output and allow the user to visualize what the document may look like when rendered. The storage medium 335 include, but are not limited to, hard drives, optical drives such as, e.g., CD and DVD drives, and floppy drives.

The user interface 325 interacts with the user of the system 300, i.e., receiving commands from the user, such as finishing options, displaying job status, and system status information to the user on the display screen 340. In some embodiments, a pointing device 105, as shown in FIG. 1, such as, e.g. a mouse or a touchpad, can be provided. The processor 330 can be configured to provide digital documents and user-programmed finishing system options to the finishing module 345 for final processing.

The digital documents 305 and 320, such as the photo job requesting specialty media, can be electronically transmitted to the rendering system 300 and a raster image then generated. The media definitions can be enhanced to include a template 355 that includes a graphical representation of the steps required to finish the photo job 305 and 320 rendered on the specialty photo media. The finishing module 345 also creates a low-resolution image for placement into the template 355.

The finishing module 345 can retrieve the template 355 associated with the selected media and place the low-resolution image in all image placeholders 360. The image placeholders 360 can include information 365 concerning how the document can be transformed as it is placed. The finishing module 345 includes several subsystems including, but not limited to, a scaling subsystem, a rotation subsystem, and other finishing system subsystems such as, for example, a skewing and offset subsystem and a folding subsystem for providing V-folding, C-folding, Z-folding capabilities and other folding parameters to the finishing module 345.

The finishing module 345 can generate finished documents 375, which are finished in accordance with user-programmed finishing parameters. The finished document with specialty media 375 and ancillary instruction document 380 with a number of thumbnails of the photos from the input document 305 and 320 can be rendered via the rendering device 108. Note that the term “thumbnail” as utilized herein generally refers to a small representation of a picture on a Web page, usually containing a hyperlink to a full-size version of the graphic. A “thumbnail” is thus a miniature copy of a graphic image.

The ancillary instruction document 380 includes instructions required to generate the final product 375 that utilizes specialty product photo media, which reduces waste of very expensive media. The finishing instructions can be alternatively represented as animations on the graphical user interface 325. Note that the specialty media products such as, for example, FlipPix can be designed for personal expression and enhanced communication. Such high quality products are ideal for presentations, promotions, and special events that ensure high quality printing characteristics.

Note that in the configuration depicted in FIG. 3, the workstation 390 is depicted as executing the finishing module 345 and its included functions locally; however, it is to be understood that this arrangement is for purposes of explaining the present application only. That is, the workstation 390 may alternately be connected to a server computer which is capable of executing the finishing module 345 remotely on the server computer and providing the results back to the workstation 390 for display on the display device 340.

It is to be further understood that the scope of the present application is not limited to any particular arrangement of workstation and peripheral devices. A part or all of the processing of each function of embodiments described herein can be realized by the finishing module 345 and executed by a computer, including the aforementioned workstation 390. The system can add actual document representations, including intermediary representations, to a set of visual “finishing” instructions for the specialty media. Note that a nominal scenario is one in which the media is “finished” by hand. This finishing may or may not require equipment (typically NOT since space is at a premium). A great deal of specialty media can be finished by peeling off sections, folding and otherwise assembling manually.

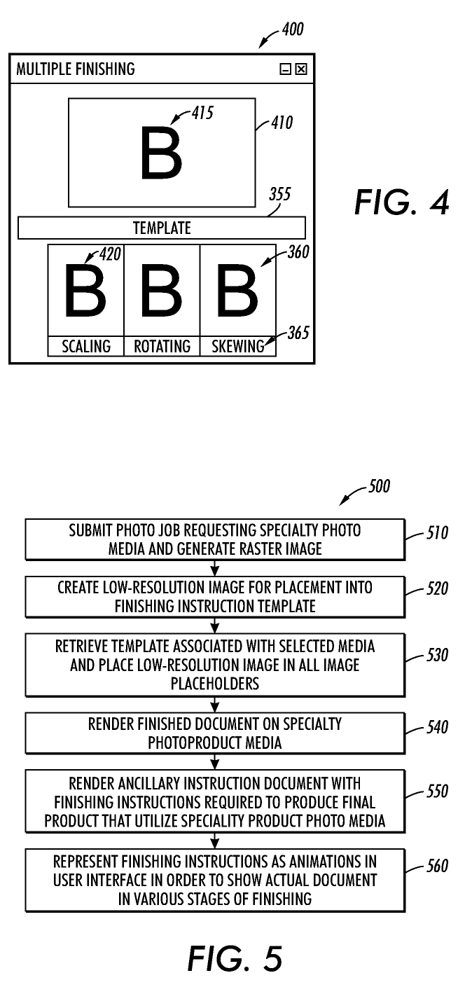

FIG. 4 illustrates a graphical user interface window 400 that displays the visual representation of instructions required to generate a finished document with specialty media 375, which can be implemented in accordance with an exemplary embodiment. The GUI window 400 is shown operating according to methods currently known in the art. Note that the term “GUI” generally refers to a type of environment that represents programs, files, options and so forth by means of graphically displayed icons, menus, and dialog boxes on a computer monitor screen. The GUI window 400 includes a display window 410 in which a finished photo product 415 with specialty media is being displayed in a WYSIWYG format. The GUI window 400 includes the template 355 associated with the selected media and places a low-resolution image 420 associated with the photo product 415 in all the image placeholders 360. The image placeholders 360 include information 365 about how the image 415 can be transformed as it is placed. For example, the image placeholders 360 are similar to Adobe Illustrator masks. The image placeholders 360 include a window through which the placed document 410 can be seen.

The photo product 415 can be placed within the display window 410 and may be offset to show a given portion of the image 415. For example, in cases like FlipPix where the die includes openings so that portions of the image in one part of the page show up in openings within portions of the image in another portion of the page. The template can define multiple placeholders atop of each other with masks that can enable the preview to display the expected show through. It is to be noted that, although the photo product 415 is to be prepared with various finishing options such as, e.g., rotating option, that the finishing options can be displayed in the image placeholders 360 in a WYSIWYG format. As required, detailed embodiments of the present invention are disclosed herein; however, it is to be understood that the disclosed embodiments are merely exemplary of the invention that may be embodied in various and alternative forms.

FIG. 5 illustrates a flow chart of operations illustrating logical operational steps of a method 500 for creating a visual representation of instructions required to finish a photo product that utilizes the specialty product photo media, in accordance with a preferred embodiment. Again as reminder, in FIGS. 1-5, identical or similar parts or elements are indicated by identical reference numerals. Note that the method 500 can be implemented in the context of a computer-useable medium that contains a program product. The method 500 depicted in FIG. 5 can also be implemented in a computer-usable medium containing a program product.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 500 described herein can be deployed as process software in the context of a computer system or data-processing system as that depicted in FIGS. 1-2.

The photo job requesting specialty photo product media can be submitted to the rendering system 300, as illustrated at the block 510. The low-resolution image for placement into the finishing instruction template 355 can then be created, as shown at block 520. Thereafter, the template 355 associated with the selected media can be retrieved and the low-resolution image 420 can be placed on the placeholders 360, as depicted at block 530. The template 355 includes a graphical representation of the steps required to finish jobs rendered on the specialty photo product media. The template 355 can also define areas into which a masked representation of the raster image processed document can be placed.

The finished document 375 can be rendered on a specialty photo product media, as illustrated at block 540. The ancillary instruction document 380 with finishing instructions required to generate the finished document 375 that utilize specialty product photo media can also be rendered, as shown at block 550. The finishing instructions can also be represented as animations in a computer screen in order to show actual document in various stages of finishing, as depicted at block 560. Such an approach associates the document template 355 with the media and automatically generates finishing instructions that show the actual document in various stages of finishing. Such a visual representation of the document finishing instructions reduces wastage of very expensive media

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for creating a visual representation of finishing instructions for specialty photo media, said method comprising:
submitting a photo job that includes a request for a specialty photo media;
generating a raster image and a low resolution image via a rendering device, wherein said low resolution image is located on at least one image place holder associated with a template of said specialty photo media; and
rendering said photo job on said specialty photo media in association with an ancillary instruction document that includes said at least one image place holder with respect to said photo job in association with finishing instructions required to generate a final photo product that utilizes said specialty photo media, thereby creating a visual representation of said finishing instructions for said specialty photo media.

2. The method of claim 1 further comprising representing said finishing instructions as animation via a graphical user interface that is capable of displaying said photo job in various stages of finishing.

3. The method of claim 1 further comprising configuring a graphical representation of steps required to finish said photo job rendered on said specialty photo media on said template,

4. The method of claim 1 further comprising placing a masked representation of said raster image on said at least one placeholder associated with said template.

5. The method of claim 1 wherein said finishing instructions comprise scaling information related to said final photo product.

6. The method of claim 1 wherein said finishing information comprises folding and media manipulation information related to said final photo product.

7. The method of claim 6 wherein said folding and media manipulation information further comprises rotation information related to said final photo product.

8. The method of claim 1 wherein said finishing information comprises skewing and offset information related to said final photo product.

9. A method for creating a visual representation of finishing instructions for specialty photo media, said method comprising:
submitting a photo job that includes a request for a specialty photo media;
generating a raster image and a low resolution image via a rendering device, wherein said low resolution image is located on at least one image place holder associated with a template of said specialty photo media;
rendering said photo job on said specialty photo media in association with an ancillary instruction document that includes said at least one image place holder with respect to said photo job in association with finishing instructions required to generate a final photo product that utilizes said specialty photo media; and
representing said finishing instructions as animation via a graphical user interface that is capable of displaying said photo job in various stages of finishing, thereby creating a visual representation of said finishing instructions for said specialty photo media.

10. The method of claim 9 further comprising configuring a graphical representation of steps required to finish said photo job rendered on said specialty photo media on said template.

11. The method of claim 9 further comprising placing a masked representation of said raster image on said at least one placeholder associated with said template.

12. The method of claim 9 wherein said finishing instructions comprise scaling information related to said final photo product.

13. A system for creating a visual representation of finishing instructions for specialty photo media, said system comprising:
a processor;
a data bus coupled to the processor; and
a computer-usable medium embodying computer code, the computer-usable medium being coupled to the data bus, the computer program code comprising instructions executable by the processor and configured for:
submitting a photo job that includes a request for a specialty photo media;
generating a raster image and a low resolution image via a rendering device, wherein said low resolution image is located on at least one image place holder associated with a template of said specialty photo media; and
rendering said photo job on said specialty photo media in association with an ancillary instruction document that includes said at least one image place holder with respect to said photo job in association with finishing instructions required to generate a final photo product that utilizes said specialty photo media, thereby creating a visual representation of said finishing instructions for said specialty photo media.

14. The system of claim 13 wherein said instructions are further configured for representing said finishing instructions as animation via a graphical user interface that is capable of displaying said photo job in various stages of finishing.

15. The system of claim 13 wherein said instructions are further configured for providing a graphical representation of steps required to finish said photo job rendered on said specialty photo media on said template.

16. The system of claim 13 wherein said instructions are further configured for placing a masked representation of said raster image on said at least one placeholder associated with said template.

17. The system of claim 13 wherein said finishing instructions comprise scaling information related to said final photo product.

18. The system of claim 13 wherein said finishing information comprises folding and media manipulation information related to said final photo product.

19. The system of claim 18 wherein said folding and media manipulation information further comprises rotation information related to said final photo product.

20. The system of claim 13 wherein said finishing information comprises skewing and offset information related to said final photo product.
